(19) United States
(12) Patent Application Publication
(10) Pub. No.: US 2025/0367951 A1
(43) Pub. Date: Dec. 4, 2025

(54) LABEL PRINTER CASSETTE AND A LABEL PRINTER

(71) Applicant: ILLINOIS TOOL WORKS INC., Glenview, IL (US)

(72) Inventors: Kevin CARTWRIGHT, Halesowen (GB); Ian TAYLOR, Kenilworth (GB); Hugh CONNELL, Alcester (GB)

(21) Appl. No.: 19/219,590

(22) Filed: May 27, 2025

(30) Foreign Application Priority Data
May 30, 2024 (GB) 2407710.9

(51) Int. Cl. B41J 15/04; B41J 3/407

(52) U.S. Cl. CPC B41J 15/044; B41J 3/4075

(57) ABSTRACT

A label printer cassette includes a body with a cavity; a hub situated within the cavity and arranged to receive a label media roll; a backing hub arranged to receive and to roll label media backing; a moveable barrier; wherein the label printer cassette is arranged to have a blocking configuration and a non-blocking configuration; in the blocking configuration the barrier is positioned to extend across the cavity from the backing hub towards a wall of the cavity to prevent unrolled label media from the label media roll being conveyed between the backing hub and the wall, in the blocking configuration the barrier partially surrounds the backing hub; in the non-blocking configuration, the moveable barrier does not partially surround the backing hub and does not extend across the cavity from the backing hub to the wall of the cavity.

### TECHNICAL FIELD

This invention relates to a label printer cassette and a label printer. In particular it relates to a label printer cassette for holding a roll of label media to be printed upon by a label printer to provide printed labels.

### BACKGROUND

Label printers are devices which can be used to print customised text, images, shapes etc. onto plain label media. Labels are typically for sticking onto goods. For example supermarkets may use label printers with a combined scale and user interface to weigh and label goods. A user may place the goods onto the scales, select the weighed goods on a user interface on a screen integrated with the printer or a separate screen, and then the label printer can print off a label which may include information such as the type of goods and the weight, as well as other information such as pricing and barcodes. The label usually has some form of adhesive on its back for sticking it onto the goods.

Label printers typically comprise label printer cassettes, which hold a supply of label media for printing on. The label printer cassettes are arranged to be installed and uninstalled from the label printer to enable reloading of label media after the supply of label media in the cassette has been used.

### SUMMARY

Aspects and embodiments of the invention provide: a label printer cassette, a label printer.

In accordance with the present disclosure, there is provided a label printer cassette for providing a supply of label media to a label printer comprising: a body with a cavity; a hub situated within the cavity, the hub being arranged to receive a label media roll and to rotate to enable the label media roll to be unrolled and conveyed towards the an exit of the cassette by the label printer; a backing hub situated within the cavity, the backing hub arranged to receive and to roll label media backing when the label media roll has label media backing; a moveable barrier; wherein the label printer cassette is arranged to have a blocking configuration and a non-blocking configuration; wherein in the blocking configuration the barrier is positioned to extend across the cavity from the backing hub towards a wall of the cavity to prevent unrolled label media from the label media roll being conveyed between the backing hub and the wall, wherein in the blocking configuration the barrier partially surrounds the backing hub to prevent unrolled label media from touching the backing hub as it is conveyed past the backing hub; wherein in the non-blocking configuration, the moveable barrier does not partially surround the backing hub and does not extend across the cavity from the backing hub to the wall of the cavity.

In some examples, the printer cassette comprises a first mounting adjacent to the backing hub and a second mounting adjacent to the wall of the cavity; wherein the moveable barrier comprises a mounting portion; wherein each of the first mounting and the second mounting are arranged to receive the mounting portion of the moveable barrier.

In some examples, in the non-blocking configuration the barrier is positioned adjacent to the wall of the cavity.

In some examples, the wall of the cavity comprises a wall mounting; wherein the moveable barrier comprises a mounting portion; wherein the wall mounting is arranged to receive the mounting portion of the moveable barrier.

In some examples a portion of the moveable barrier conforms to a portion of the backing hub when in the blocking configuration.

In some examples, the moveable barrier is removable from the label printer cassette.

In accordance with the present disclosure, there is provided a label printer cassette for providing a supply of label media to a label printer, comprising: a body with a cavity; a hub situated within the cavity, the hub being arranged to receive a label media roll and to rotate to enable the label media roll to be unrolled, wherein the label media roll comprises a tube with label media rolled around the tube; wherein the hub comprises: two flanges, a spindle extending between the two flanges, a plurality of lever bars surrounding the spindle, each lever bar mounted on each of the two flanges; wherein one of the flanges comprises a roll engaging surface, arranged to contact the inner surface of the tube of the label media roll to enable rotation of the label media roll when the hub rotates; wherein each of the plurality of lever bars comprises a label media roll engagement portion arranged to project at a radial distance from a rotational axis of the spindle which is larger than a radial distance of the roll engaging surface from the rotational axis of the spindle, wherein each of the plurality of lever bars is arranged to torsionally deflect when the label media roll hub is inserted onto the hub, wherein the torsional deflection of each of the plurality of lever bars applies a reaction force onto the inner surface of the roll.

In some examples, each of the engagement portions of the plurality of levers bars project in a direction which opposes a direction of rotation for the hub when the label media roll is unrolled.

In some examples, each of the plurality of lever bars are pivotally mounted to the two flanges, wherein each of the plurality of lever bars is arranged to pivot between two end positions.

In some examples, each of the plurality of lever bars comprises an abutment portion, wherein the abutment portion is located within one of the flanges; wherein the hub comprises one or more abutment surfaces, wherein each abutment portion is arranged to abut one of the one or more abutment surfaces, wherein the abutment of each abutment portion with the one or more abutment surfaces enables the tortional deflection of each respective lever bar.

In some examples, the one or more abutment surfaces comprises a portion of the spindle that runs through said flange.

In some examples, each of the plurality of lever bars is bent so that there is an acute angle between the engagement portion and the abutment portion.

In some examples, each engagement portion comprises a slope from the mounting on the flange comprising the roll engaging surface up to a part of the engagement portion which projects with the maximum radial distance from the rotational axis.

In accordance with the present disclosure, there is provided a label printer cassette for providing a supply of label media to a label printer, comprising: a body with a cavity; a hub situated within the cavity, the hub being arranged to receive a label media roll and to rotate to enable the label media roll to be unrolled; a support plate; a side support on one side of the support plate; a guide member protruding from the plane of the support plate; an adjustment mechanism arranged to adjust the distance between the guide member and the side support; wherein the support plate, side support and guide member are arranged to support and guide unrolled label media from the label media roll as it is conveyed from the label media roll towards an exit of the cassette by the label printer.

In some examples, the adjustment mechanism comprises a lead-screw. In some examples, the lead screw is a spring lead-screw.

In some examples, the adjustment mechanism comprises a gear arrangement.

In some examples, the adjustment mechanism is arranged so that the gear arrangement is connected to the lead screw, wherein rotational movement of a first gear of the gear arrangement in a first rotational direction translates into linear movement of the guide member in a first linear direction and wherein rotational movement of the first gear in a second rotational direction, opposite to the first rotational direction, translates into linear movement of the guide member in a second linear direction, opposite to the first linear direction; wherein movement of the guide member in the first linear direction increases the distance between the guide member and the side support, and movement of the guide member in the second linear direction decreases the distance between the guide member and the side support.

In some examples, the gear arrangement is adjacent to the side support or is within the side support.

In some examples, the support plate comprises a slot, wherein the guide member is located within the slot.

In some examples, the support plate comprises a surface with grooves.

In some examples, the support plate is inclined relative to the hub.

In accordance with the present disclosure, there is provided a label printer, and a label printer cassette as described in any preceding paragraph installed into the printer, wherein the label printer cassette supplies label media to the label printer for printing labels.

### BRIEF DESCRIPTION OF THE DRAWINGS

Example embodiment(s) of the invention are illustrated in the accompanying drawings, in which:

FIG. 1A illustrates a label printer cassette according to examples disclosed herein;

FIG. 1B illustrates a schematic of a label printer and a label printer cassette according to examples disclosed herein;

FIG. 2 illustrates part of a label printer cassette according to examples disclosed herein;

FIG. 3 illustrates a hub of a label printer cassette according to examples disclosed herein;

FIG. 4A illustrates a schematic of a label media roll according to examples disclosed herein;

FIG. 4B illustrates a schematic of a label media roll according to examples disclosed herein;

FIG. 5 illustrates a hub of a label printer cassette according to examples disclosed herein;

FIG. 6 illustrates an exploded view of a hub of a label printer cassette according to examples disclosed herein;

FIG. 7A illustrates a label printer cassette according to examples disclosed herein;

FIG. 7B illustrates part of a label printer cassette according to examples disclosed herein;

FIG. 8 illustrates a label printer cassette according to examples disclosed herein;

FIG. 9A illustrates a label printer cassette according to examples disclosed herein;

FIG. 9B illustrates a label printer cassette according to examples disclosed herein;

FIG. 10 illustrates part of a label printer cassette according to examples disclosed herein;

FIG. 11A-11C illustrate part of a label printer cassette according to examples disclosed herein.

### DETAILED DESCRIPTION

Label printer cassettes typically comprise an open sided design, which enables installing and uninstalling the cassette onto the printer. The cassette can comprise mounting portions, which can for example include prongs to insert onto receptacles on the printer and/or receptacles to receive prongs from the printer. The cassette typically comprises an open side and a closed side so that when the cassette is installed in the printer, the closed side forms part of the exterior of the printer, which prevents users of the printer from being able to see or interact with the interior mechanisms of the printer and the printer cassette whilst the printer is in use.

The label media which is stored in the label media cassette is typically provided on a roll, which is received by a hub. The hub is arranged to rotate to enable unrolling of the label media. To maintain correct placement of the label media as it is unrolled, label media cassettes have used a label roll retention lever, which is separate to the hub in the cassette. The label roll retention lever contacts the side of the label media roll as it is unrolled to maintain correct position. The label roll retention lever also prevents a label roll dislodging while the cassette is inserted into the printer. However the disadvantage of label roll retention levers is they require separate adjustment and can come loose under impact.

Label printer cassettes can also comprise integral moulded arms along the length of the hub. However after a period of use these can take a set in a particular position which does not grip the label media roll optimally and therefore the hub can lose its ability to grip the label media roll.

Label printers may be required to print using different types of label media. For example it may be required to use lined label media, which comprises media for printing on with backing paper stuck to its back which needs to be removed so that the adhesive on the printed media can be stuck onto goods. Alternatively the label media may be liner-less where the media does not have backing paper so that the printed labels can be stuck onto goods without having to peel off backing paper. Label media can also comprise die-cut labels on backing paper, where the label size is predetermined, or continuous media which typically requires ripping from the rest of the media roll to attach onto goods.

The different types of label media described have different requirements for storage and conveying for printing. Label printers have therefore required different label printer cassettes for different types of label media. For example a label printer cassette for lined label media requires the use of a backing hub which is used to take up the backing paper of the label media. As the label media for printing on is separated from the backing paper near to or at the exit of the label printer cassette, there is no requirement for the cassette to have anti-adhesive surfaces for preventing sticking of the label media to the cassette as it is conveyed through the interior of the cassette. In contrast, a label printer cassette for a liner-less label media does not require the use of a backing hub, and does require at least some of the internal surfaces of the label printer cassette to have anti-adhesive surfaces which prevent the liner-less media from sticking to the interior surfaces of the label printer cassette as it is conveyed through the cassette. Therefore, disadvantageously, two types of label printer cassette are required for the label printer to switch between lined and liner-less label media, which requires further manufacturing and storage. Additionally, users responsible for installing and uninstalling the label printer cassette from the label printer are required to know the differences between the cassettes and which one needs to be used for a certain type of label media.

To ensure that the label media is conveyed out of the label printer cassette correctly, there is typically some form of guide built into the label printer cassette. For example previous label printer cassettes have required feeding the label media through a gap formed by a label guide, a label guide rod and an interior wall of the cassette. Label guides such as these are cumbersome and tedious to use, increasing the time needed to replace label media in a cassette. As they require careful attention by the user installing label media into the cassette, such label guides are prone to malfunction.

There are therefore challenges in providing a label printer cassette which: reliably unrolls the label media as it is conveyed for printing; guides label media as it is conveyed through to the exit of the label media cassette; eliminates the need for different cassettes for different types of label media. Examples disclosed herein provide examples of addressing these challenges by providing a new, improved hub, a new, improved label media guide and a new, improved multi-functional cassette which enables one type of cassette to be used for different types of label media.

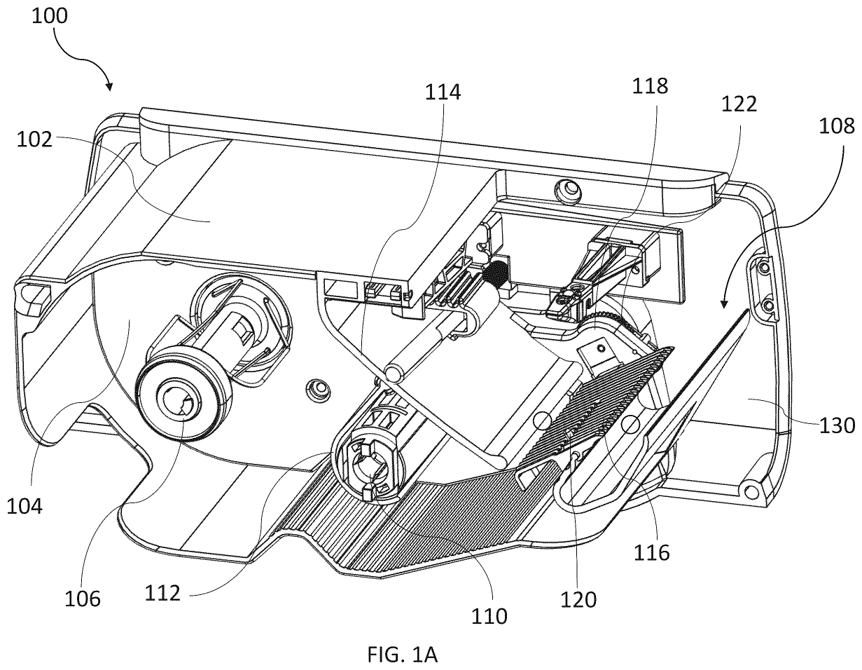

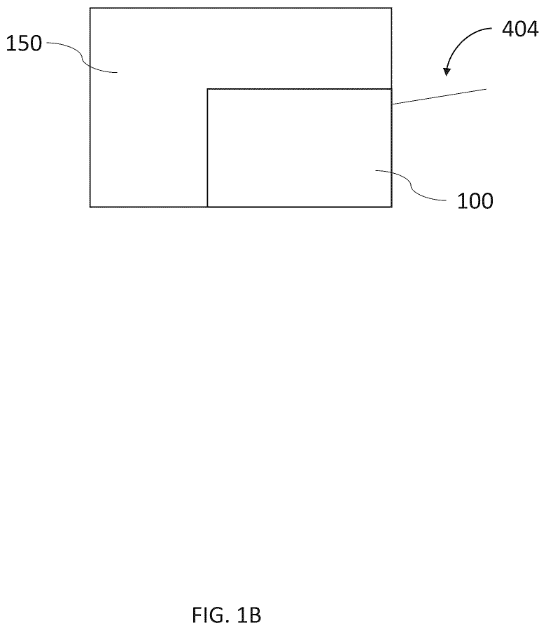

FIG. 1A shows a label printer cassette 100 according to examples disclosed herein. As shown in FIG. 1A, the label printer cassette 100 has an open side and a closed side, in particular the closed side is formed by the side wall 130. The label printer cassette 100 comprises a body 102, with a cavity 104. The cavity 104 is not an enclosed cavity due to the open side of the label printer cassette 100.

The label printer cassette 100 comprises a hub 106 situated within the cavity 104. The hub 106 is arranged to receive a label media roll and to rotate to enable the label media roll to be unrolled. The label media roll, shown in later Figures, comprises a tube with label media rolled around the tube.

The hub 106 is arranged to be inserted onto a printer spindle of the label printer (not shown). In the example shown in FIG. 1A, the hub 106 comprises a spindle which has a receptacle to be inserted onto the printer spindle of the label printer. The label printer rotates the hub 106 to unroll the label media by rotating the printer spindle of the label printer upon which the hub 106 is mounted. The body 102 comprises all of the parts of the printer cassette 100 except the hub 106, and other parts described herein including: a backing hub 110, a moveable barrier 112, a guide member 120 and a support plate 116.

According to examples disclosed herein, as the label media is conveyed through the cassette 100 it passes underneath a backing hub 110 and moveable barrier 112, and passes by guide member 120 and over support plate 116 towards the exit 108 of the cassette 100. When the cassette 100 is installed in the printer, the parts of the printer responsible for the printing of ink onto the label media are located in the vicinity of the support plate 116, guide member 120, exit 108. The gap in the body 102 around this location accommodates these parts of the printer. The printer may be a thermal printer. The printer can have motorised rollers/spindles or other mechanisms to convey the label media through the cassette 100 to be printed on.

According to examples disclosed herein, label printer cassettes 100 are provided which have variations from the label printer cassette illustrated in FIG. 1A.

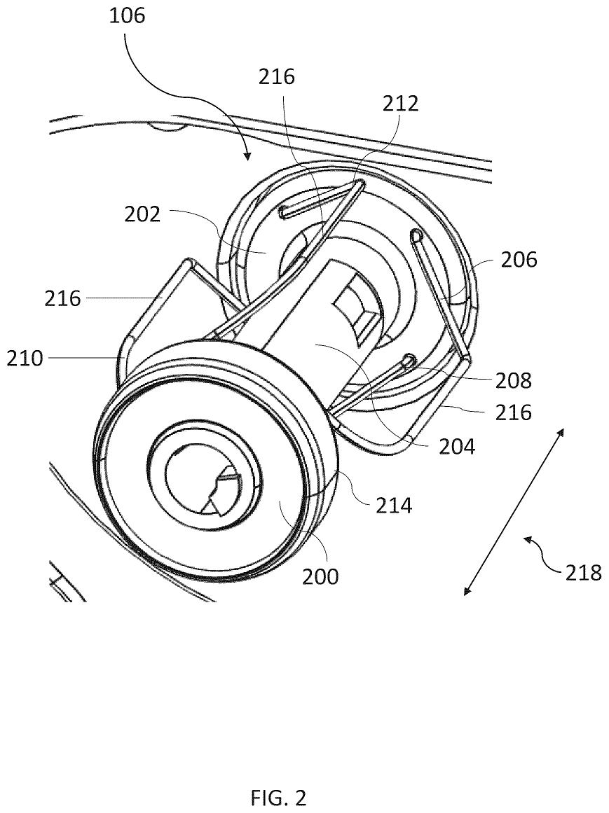

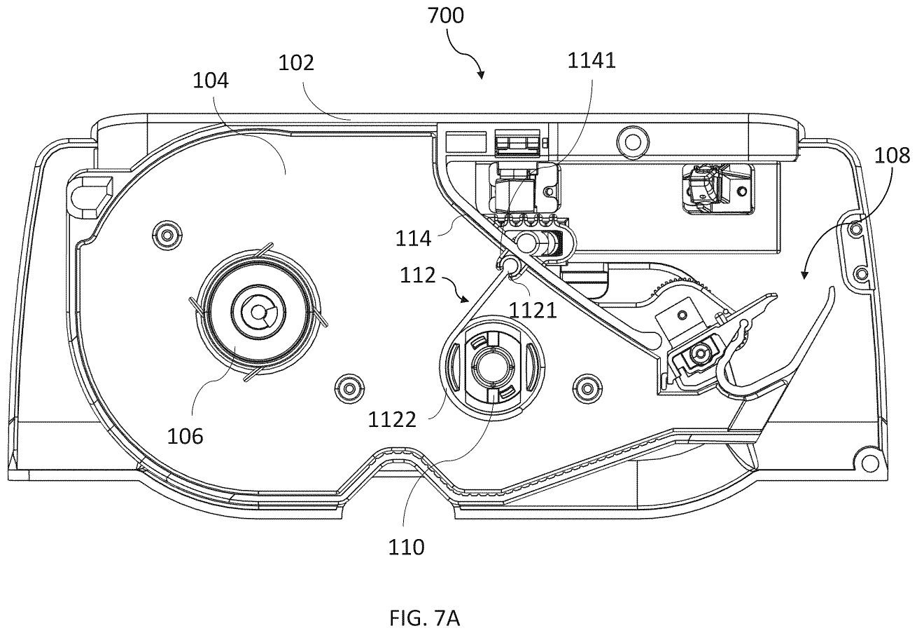

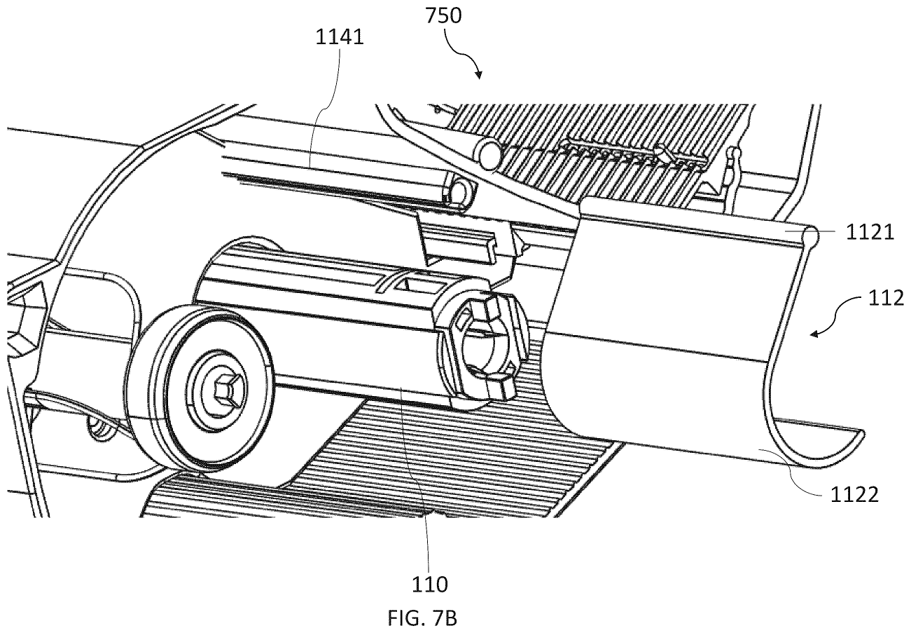

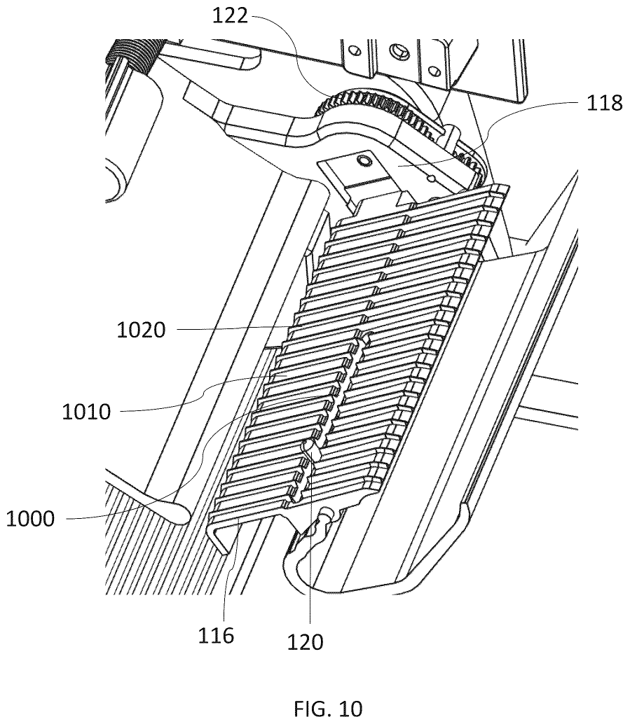

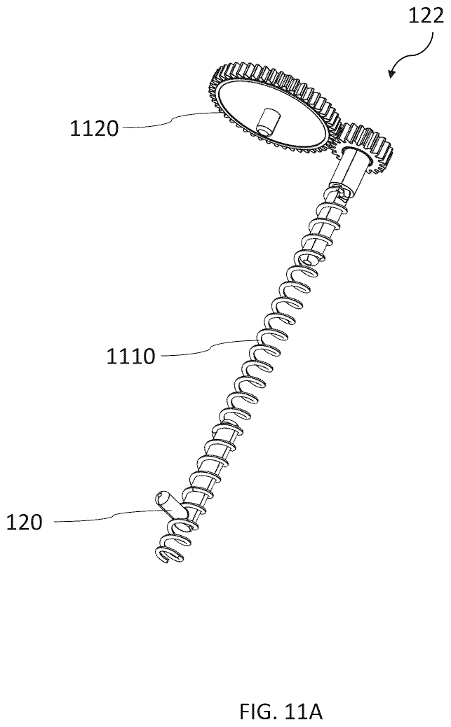

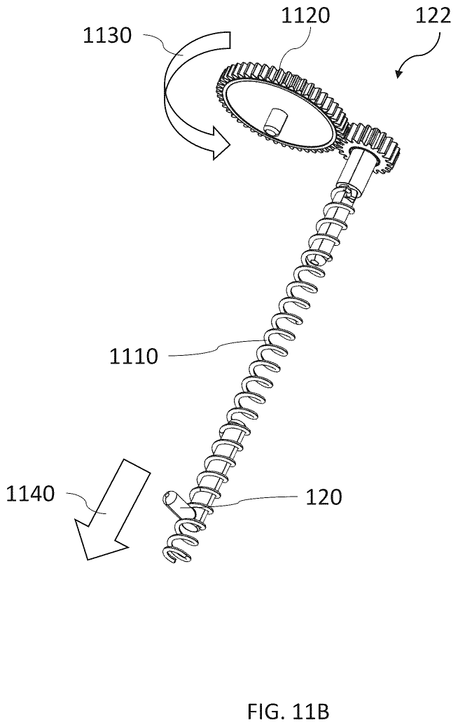

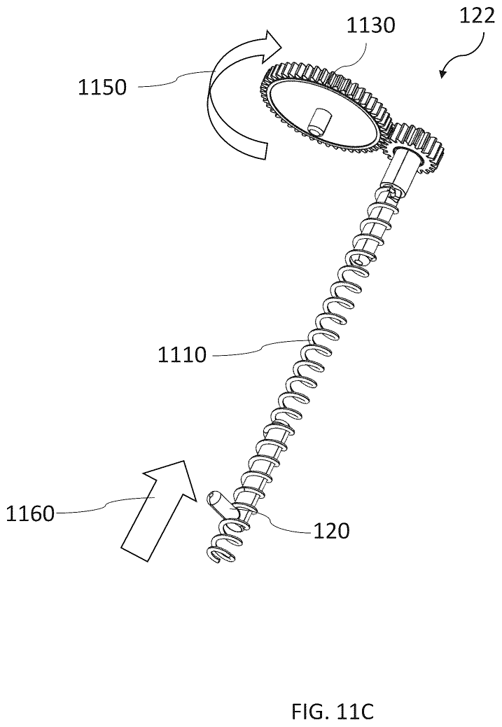

For example, a printer cassette 100 can be provided which comprises the hub 106 shown in FIG. 1A and described herein with reference to FIGS. 2-6, but does not comprise the moveable barrier 112 and the backing hub 110 described herein with reference to FIGS. 7A-9B. Additionally or alternatively, a printer cassette 100 can be provided which comprises the hub 106 shown in FIG. 1A and described herein with reference to FIGS. 2-6, but does not comprise the guide member 120 and/or the support plate 116 described herein with reference to FIGS. 10-11C. For example a label printer cassette 100 can be provided with the hub 106 shown in FIG. 1A and described herein with reference to FIGS. 2-6 with alternative parts to those described herein.

As another example, a label printer cassette 100 can be provided which comprises the moveable barrier 112 and the backing hub 110 shown in FIG. 1A and described herein with reference to FIGS. 7A-9B, but does not comprise the hub 106 described herein with reference to FIGS. 2-6. Additionally or alternatively, a label printer cassette 100 can be provided which comprises the moveable barrier 112 and the backing hub 110 and described herein with reference to FIGS. 7A-9B, but does not comprise the guide member 120 and/or the support plate 116 described herein with reference to FIGS. 10-11C. For example a printer cassette 100 can be provided with the moveable barrier 112 and the backing hub 110 shown in FIG. 1A and described herein with reference to FIGS. 7A-9B with alternative parts to those described herein.

As another example, a label printer cassette 100 can be provided which comprises the guide member 120 and/or the support plate 116 described herein with reference to FIGS. 10-11C, but does not comprise the hub 106 described herein with reference to FIGS. 2-6. Additionally or alternatively, a printer cassette 100 can be provided which comprises the guide member 120 and/or the support plate 116 described herein with reference to FIGS. 10-11C, but does not comprise the moveable barrier 112 and the backing hub 110 and described herein with reference to FIGS. 7A-9B. For example a printer cassette 100 can be provided with the guide member 120 and/or support plate 116 shown in FIG. 1A and described herein with reference to FIGS. 10-11C with alternative parts to those described herein.

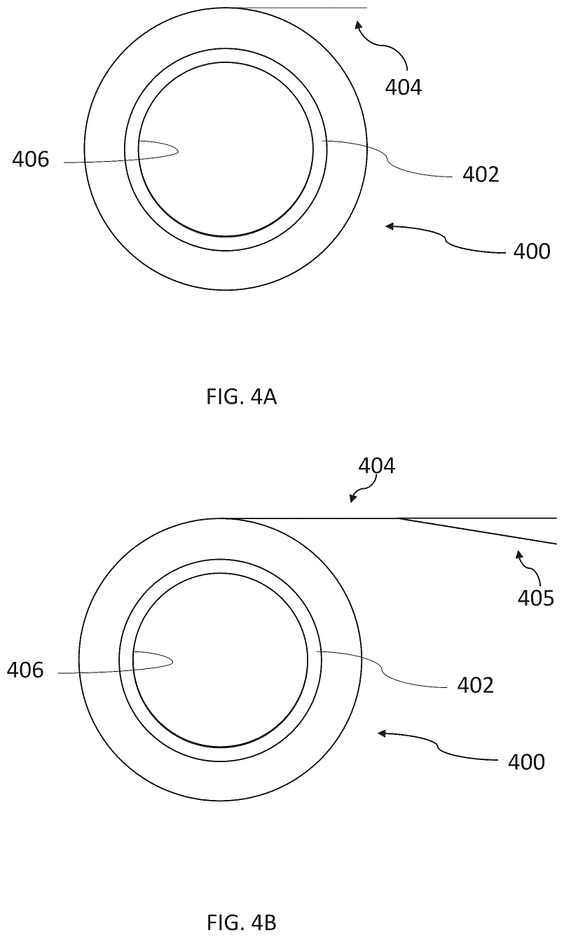

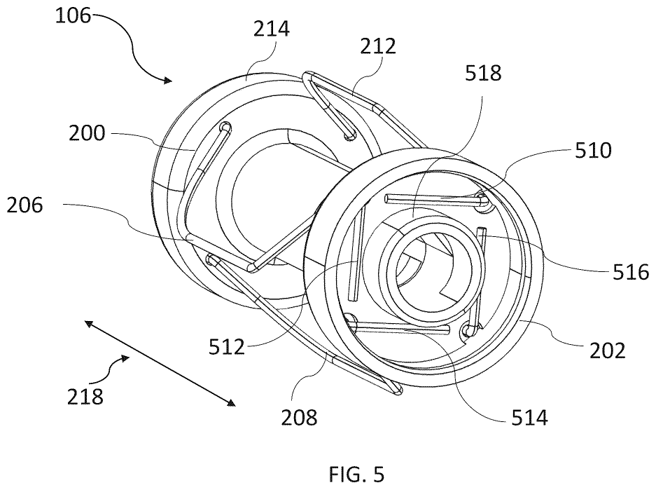

FIG. 1B shows a schematic of a label printer 150 and a label printer cassette 100 according to examples disclosed herein. As shown in FIG. 1B, the label printer cassette 100 has been installed into the label printer 150. The label printer cassette 100 may have a label media roll 400 (see FIGS. 4A-5B) installed on its hub 106. Alternatively the label printer cassette 100 can be installed into the label printer 150 without a label media roll 400, for storage of the label printer cassette 100 whilst not in use and to protect its mechanisms and the mechanisms of the label printer 150. FIG. 1B therefore shows a label printer 150, and a label printer cassette 100, where the label printer cassette 100 supplies label media 404 to the label printer 150 for printing labels.

FIG. 1B shows the side wall 130 of the cassette facing the external environment, which hides the mechanisms of the label printer 150 and the label printer cassette 100, and the label media roll 400, from view. Label media 404 which has been printed on is shown as exiting the combined label printer 150 and label printer cassette 100. Label printer 150 may have a tear-off strip or other mechanism to allow printed label media 404 and/or backing to be torn off.

FIG. 2 shows part of a label printer cassette 100 according to examples disclosed herein. In particular FIG. 2 shows a hub 106 of the cassette 100 according to examples disclosed herein.

The hub 106 comprises: two flanges 200, 202; a spindle 204 extending between the two flanges 200, 202; a plurality of lever bars 206, 208, 210, 212 surrounding the spindle. Each lever bar 206, 208, 210, 212 is mounted on each of the two flanges 200, 202. One of the flanges, in particular flange 200 in the example shown in FIG. 2, comprises a roll engaging surface 214. The roll engaging surface 214 is arranged to contact the inner surface of the tube of the label media roll 400 to enable rotation of the label media roll 400 when the hub 106 rotates.

Each of the plurality of lever bars 206, 208, 210, 212 comprises a label media roll engagement portion 216 arranged to project at a radial distance from a rotational axis 218 of the spindle 204 which is larger than a radial distance of the roll engaging surface 214 from the rotational axis 218 of the spindle 204. As shown in FIG. 2, according to examples herein the rotational axis 218 of the spindle 204 extends in a direction parallel to the length of the spindle 204.

Each of the plurality of lever bars 206, 208, 210, 212 is arranged to torsionally deflect when the label media roll 400 is inserted onto the hub 106. The torsional deflection of each lever bar 206, 208, 210, 212 applies a reaction force onto the inner surface of the label media roll 400.

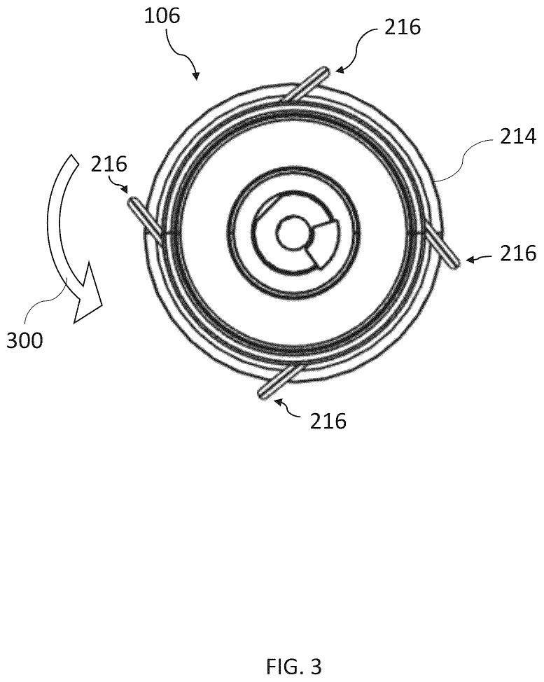

FIG. 3 shows a hub 106 of a label printer cassette 100 according to examples disclosed herein. In particular, FIG. 3 shows a plan view of the hub 106 with the rotational axis 218 of the spindle 204 going into/out of the page.

As shown in FIG. 3, the label media roll engagement portions 216 of each lever bar 206, 208, 210, 212 project a radial distance from the rotational axis 218 of the spindle (not shown but is situated at the centre of the hub shown in FIG. 3) which is larger than the radial distance of the roll engaging surface 214 from the rotational axis 218 of the spindle 204.

Advantageously the reactional force provided by the torsional deflection of each lever bar 206, 208, 210, 212 means that no setting is required at all and the need for a separate label roll retention lever and integral moulded arms on the spindle is no longer required, which were more prone to losing grip or coming loose than the plurality of lever bars 206, 208, 210, 212. This therefore provides a more reliable mounting of the label media roll 400 onto the hub 106 for unrolling the label media, resulting in less malfunctions of the label media roll 400 not being unrolled properly. The hub 106 according to examples disclosed herein can also hold the weight of a roll 400 of label media against gravity, which makes it easier to load the cassette 100 into the label printer 150.

Arrow 300 in FIG. 3 shows the direction of rotation of a label media roll 400 to be unrolled when mounted on the hub 106. Each of the engagement portions 216 of the plurality of levers bars 206, 208, 210, 212 project in a direction which opposes the direction 300 of rotation for the hub 106 when the label media roll is unrolled. This encourages the torsional deflection of the lever bars 206, 208, 210, 212, thereby further ensuring the reactional force onto the inner surface of the roll to maintain the correct mounting and the rolling of the label media roll 400.

FIG. 4A shows a schematic of a label media roll 400 according to examples disclosed herein. In particular FIG. 4A shows label media 404 which does not have backing. The label media roll 400 comprises label media 404 rolled around a tube 402. Tube 402 has an inner surface 406 which contacts the roll engaging surface 214 of the hub 106 when mounted onto the hub 106. One side of the label media 404 is for printing on, and the reverse side of the label media 404 can have adhesive for sticking the label onto goods.

FIG. 4B shows a schematic of a label media roll 400 according to examples disclosed herein. In particular, FIG. 4B shows label media 404 which has backing 405, which can be separated from the label media 404. The label media 404 and backing 405 is rolled around a tube 402. Tube 402 has an inner surface 406 which contacts the roll engaging surface 214 of the hub 106 when mounted onto the hub 106. One side of the label media 404 is for printing on. The reverse side of the label media 404 is stuck to the backing 405. When the backing 405 is peeled off, this exposes an adhesive surface of the label media 404 which can be used to stick the label onto goods. As described herein, the label media 404 can be die-cut so that the printed labels have a predefined size. In examples where the labels are die-cut, the backing can be continuous. In other examples the label media 404 is continuous.

FIG. 5 shows a hub 106 of a label printer cassette 100 according to examples disclosed herein.

In examples disclosed herein, each of the plurality of lever bars 206, 208, 210, 212 are pivotally mounted to the two flanges 200, 202. Each of the plurality of lever bars 206, 208, 210, 212 is arranged to pivot between two end positions. In FIG. 5 each of the plurality of lever bars 206, 208, 210, 212 are shown as being between the two end positions.

As shown in FIG. 5, according to examples each of the plurality of lever bars 206, 208, 210, 212 comprises an abutment portion 510, 512, 514, 516. Each abutment portion 510, 512, 514, 516 is located within one of the flanges, in particular in FIG. 5 they are located within flange 202. In other examples the abutment portions 510, 512, 514, 516 may be within the other flange 200. In other examples the plurality of lever bars 206, 208, 210, 212 may contain abutment portions 510, 512, 514, 516 on each end which are contained within each of the flanges 200, 202.

As shown in FIG. 5, according to examples disclosed herein the hub 106 comprises one or more abutment surfaces 518. Each abutment portion 510, 512, 514, 516 is arranged to abut one of the one or more abutment surfaces 518. The abutment of each abutment portion 510, 512, 514, 516 with the one or more abutment surfaces 518 enables the tortional deflection of each respective lever bar 206, 208, 210, 212. In particular abutment of each abutment portion 510, 512, 514, 516 with the one or more abutment surfaces 518 occurs at one of the end positions of the pivotal mounting of the plurality of lever bars 206, 208, 210, 212. The abutment portions 510, 512, 514, 516 contact the circular inner surface of the flange 202 in the other end position, which prevents movement of lever bars 206, 208, 210, 212 into incorrect positions. As shown in FIG. 5 and according to examples disclosed herein, the one or more abutment surfaces 518 comprises a single circular abutment surface. In other examples other shapes of the one or more abutment surfaces are provided, and in some examples multiple abutment surfaces 518 are provided. For example, four separate and straight abutment surfaces 518 can be provided.

As shown in FIG. 5, according to examples disclosed herein the one or more abutment surfaces 518 comprises a portion of the spindle 204 that runs through said flange 202.

According to examples and as shown in FIG. 5, each of the plurality of lever bars 206, 208, 210, 212 is bent so that there is an acute angle between the label media roll engagement portion 216 and the abutment portion 510, 512, 514, 516. This has the advantage of providing the label media roll engagement portion 216 of each lever bar 206, 208, 210, 212 so that it projects in a direction which opposes the direction 300 of rotation for the hub 106 when the label media roll 400 is unrolled.

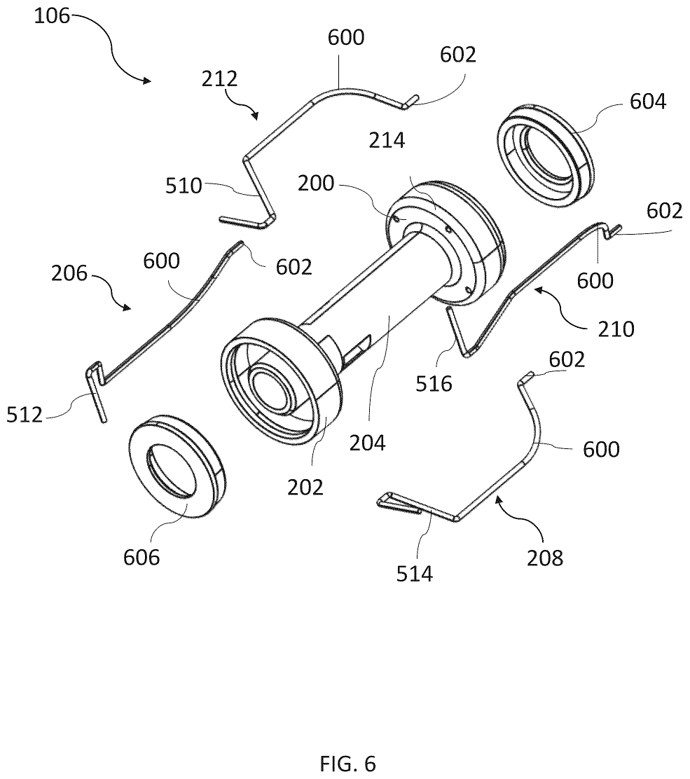

FIG. 6 shows an exploded view of a hub 106 of a label printer cassette 100 according to examples disclosed herein.

As shown in FIG. 6 and other Figures, according to examples each of the label media roll engagement portions 216 of the plurality of lever bars 206, 208, 210, 212 comprises a slope 600 from the mounting 602 on the flange 200 comprising the roll engaging surface 214 up to a part of the label media roll engagement portion 216 which projects with the maximum radial distance from the rotational axis 218 of the spindle 204. This enables easier engagement of the label media roll 400 onto the hub 106 as the inner surface 406 of the tube 402 engages the slope 600 as it is pushed onto the hub 106, and gradually slides up the slope 600 as the label media roll 400 is pushed onto the hub 106. Additionally as shown in FIG. 6, according to examples, an end cap 604 can be provided for flange 200, and another end cap 606 can be provided for flange 202.

FIG. 7A shows a label printer cassette 100 according to examples disclosed herein.

As with other examples disclosed herein, the label printer cassette 100 shown in FIG. 7A is for providing a supply of label media 404 to a label printer 150. The label printer cassette 100 comprises: a body 102 with a cavity 104; a hub 106 situated within the cavity 104. The hub 106 is arranged to receive a label media roll 400 and to rotate to enable the label media roll 400 to be unrolled and conveyed towards an exit 108 of the cassette 100 by the label printer 150.

The label printer cassette 100 shown in FIG. 7A comprises a backing hub 110 situated within the cavity 104. The backing hub 110 is arranged to receive and to roll backing 405 when the label media roll 400 has backing 405. The label printer cassette 100 shown in FIG. 7A also comprises a moveable barrier 112. According to examples, the label printer cassette 100 is arranged to have a blocking configuration 700, 900 and a non-blocking configuration 750, 800. In FIG. 7A, an example of a label printer cassette 100 in a blocking configuration 700 is shown.

In the blocking configuration 700, 900 the moveable barrier 112 is positioned to extend across the cavity 104 from the backing hub 110 towards a wall 114 of the cavity 104 to prevent unrolled label media 404 from the label media roll 400 being conveyed between the backing hub 110 and the wall 114. In the blocking configuration 700, 900, the moveable barrier 112 partially surrounds the backing hub 110 to prevent unrolled label media 404 from touching the backing hub 110 as it is conveyed past the backing hub 110.

In the non-blocking configuration 750, for example as shown in FIG. 7B, the moveable barrier 112 does not partially surround the backing hub 110 and does not extend across the cavity 104 from the backing hub 110 to the wall 114 of the cavity 104.

As shown in FIG. 7A, according to examples the wall of the cavity comprises a wall mounting 1141, and the moveable barrier 112 comprises a mounting portion 1121. The wall mounting 1141 is arranged to receive the mounting portion 1121 of the moveable barrier 112.

According to examples, a portion 1122 of the moveable barrier conforms to a portion of the backing hub 110 when in the blocking configuration 700, for example as shown in FIG. 7A. This helps to locate the movable barrier 112 in the correct location to block label media 404 from being conveyed over the backing hub 110 and to prevent the label media 404 from touching the backing hub 110 as it is conveyed past the backing hub 110.

FIG. 7B shows part of a label printer cassette 100 according to examples disclosed herein. In particular, FIG. 7B shows that, according to examples, the moveable barrier 112 is removable from the label printer cassette 100. In this particular example, the movable barrier 112 is in a sliding arrangement with the wall mounting 1141 to enable changing between the non-blocking configuration 750 and the blocking configuration 700. In particular the mounting portion 1121 of the moveable barrier 112 is in a sliding arrangement with the wall mounting 1141.

As shown in FIG. 7B, when the label printer cassette 100 is in the non-blocking configuration 750, the label backing hub 110 can be used to roll backing 405 when the label printer cassette 100 is being used to convey label media 404 with backing 405 to be printed on.

The movable barrier 112 thereby enables the label printer cassette 100 to transition between a blocking configuration 700, 900 and an non-blocking configuration 750, 800, which enables the label printer cassette 100 to switch between using label media 404 without backing and label media 404 with backing 405. This is beneficial because the same label printer cassette 100 can be used for the different types of label media instead of having to use two different types of label printer cassette 100. The movable barrier 112 also enables easy identification of which configuration the label printer cassette 100 is in (i.e. which label media can currently be used), which can be beneficial for users instead of having two different types of printer cassette 100, where the differences in which type of label media is to be used is not immediately apparent.

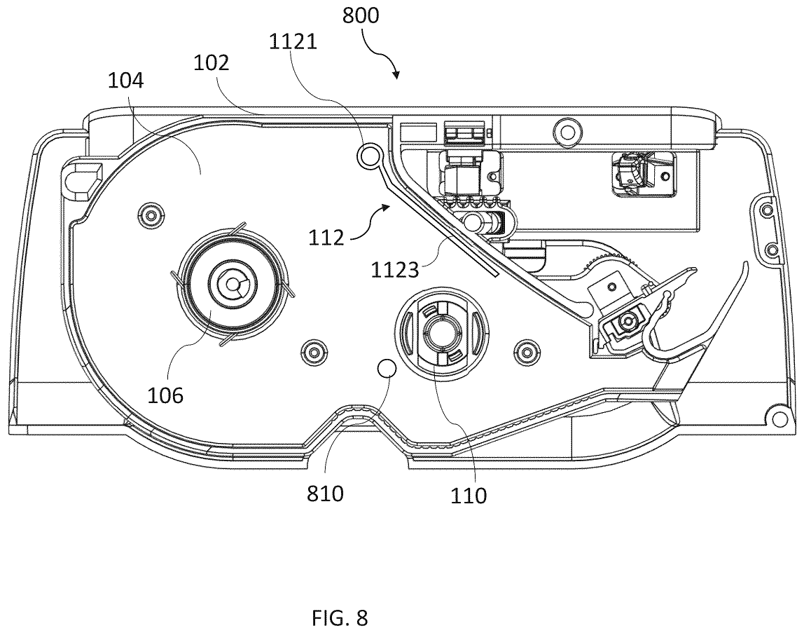

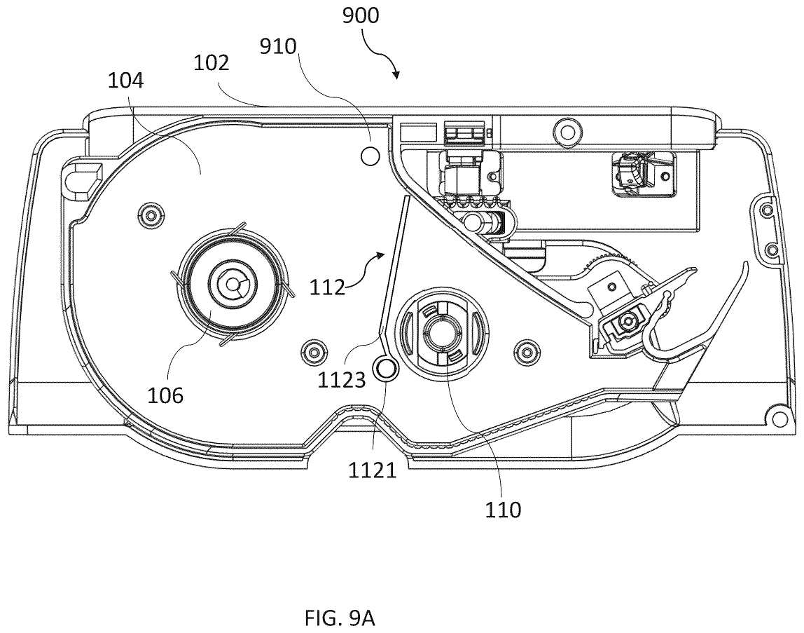

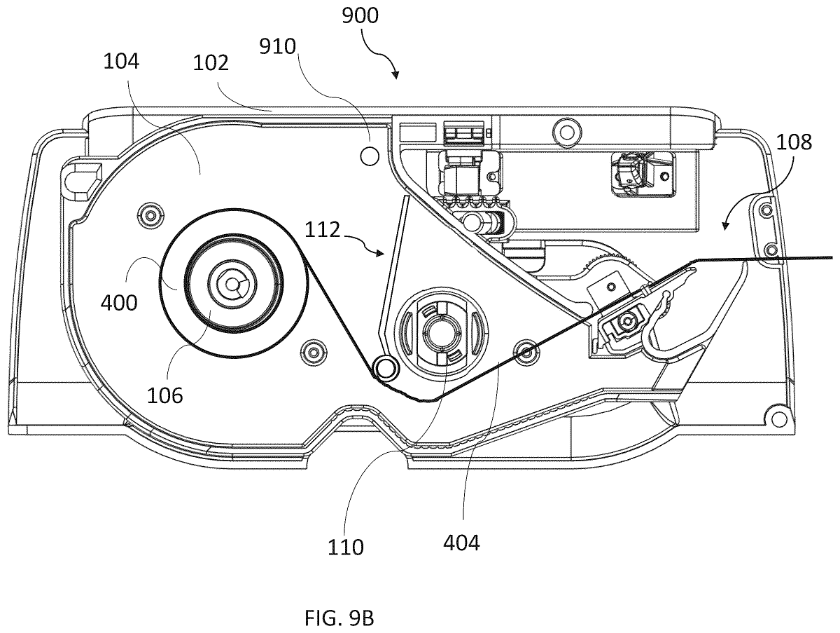

FIGS. 8, 9A, 9B show a label printer cassette 100 according to examples disclosed herein.

FIG. 8 shows a label printer cassette 100 for providing a supply of label media 404 to a label printer 150. The label printer cassette 100 comprises: a body 102 with a cavity 104; a hub 106 situated within the cavity, the hub 106 being arranged to receive a label media roll 400 and to rotate to enable the label media roll 400 to be unrolled and conveyed towards an exit 108 of the cassette by the label printer. The label printer cassette 100 also comprises a backing hub 110 situated within the cavity 104. The backing hub 110 is arranged to receive and to roll backing 405 when the label media roll has backing 405.

The label printer cassette 100 shown in FIG. 8 comprises a moveable barrier 112. The label printer cassette 100 is arranged to have a blocking configuration 900 and a non-blocking configuration 800.

In the blocking configuration 900, as shown in FIG. 9A and FIG. 9B, the barrier 112 is positioned to extend across the cavity 104 from the backing hub 110 towards a wall 114 of the cavity 104 to prevent unrolled label media 404 from the label media roll 400 being conveyed between the backing hub 110 and the wall 114. In the blocking configuration 900, the barrier 112 partially surrounds the backing hub 110 to prevent unrolled label media 404 from touching the backing hub 110 as it is conveyed past the backing hub 110.

In the non-blocking configuration 800 as shown in FIG. 8, the moveable barrier 112 does not partially surround the backing hub 110 and does not extend across the cavity 104 from the backing hub 110 to the wall 114 of the cavity 104.

The label printer cassette 100 in FIGS. 8, 9A and 9B comprises a first mounting 810 adjacent to the backing hub 110 and a second mounting 910 adjacent to the wall 114 of the cavity. The moveable barrier 112 comprises a mounting portion 1121, and each of the first mounting 810 and the second mounting 910 are arranged to receive the mounting portion 1121 of the moveable barrier 112. This enables easy switching between the non-blocking configuration 800 and the blocking configuration 900.

As shown in FIG. 8, in the non-blocking configuration 800 the barrier 112 is positioned adjacent to the wall 114 of the cavity 104. This keeps the movable barrier 112 within the label printer cassette 100 for storage but also keeps the movable barrier 112 out of the way for when the backing hub 110 is to be used to roll backing 405.

FIGS. 9A and 9B show the label printer cassette 100 in the blocking configuration 900. As shown in FIGS. 9A and 9B, a portion 1123 of the movable barrier extends from the backing hub 110 towards the wall 114 of the cavity 104, which prevents the label media 404 from being conveyed over the top of the backing hub 110 between the backing hub 110 and the wall 114. The position of the first mounting 810 means that when in the blocking configuration 900, the movable barrier 112 at least partially surrounds the label backing hub 110 so that it prevents the unrolled label media 404 from the hub 106 from touching backing hub 110 as it is conveyed past the backing hub 110.

FIG. 9B shows the label printer cassette 100 with a roll 400 of label media loaded onto the hub 106. A length of the label media 404 is shown as extending through the cavity 104 towards the exit 108 and is directed by the movable barrier 112 mounted in the first mounting 810 to pass below the backing hub 110 instead of over the top of the backing hub 110 between the backing hub 110 and the wall 114. It is understood that the path taken by the label media 404 in FIG. 9B is for illustrative purposes only and in reality there may be minor differences in the actual path taken by the label media 404. For example after the label media 404 has passed the movable barrier 112 it may droop more below the backing hub 110 than shown and rise up towards the exit 108 later than shown.

As with the label printer cassette 100 shown in FIGS. 7A and 7B, the movable barrier 112 shown in FIGS. 8, 9A and 9B thereby enables the label printer cassette 100 to transition between the non-blocking configuration 800 and the blocking configuration 900, which enables the label printer cassette 100 to switch between using label media 404 without backing and label media 404 with backing 405. This is beneficial because the same label printer cassette 100 can be used for the different types of media 404 instead of having to use two different types of label printer cassette 100. The movable barrier 112 also enables easy identification of which configuration the label printer cassette 100 is in (i.e. which label media 404 can currently be used), which can be beneficial for users instead of having two different types of printer cassette 100, where the difference in which type of media 400 is to be used is not immediately apparent. Advantageously, the moveable barrier 112 shown in the example of FIG. 8, 9A and 9B can be stored in the label printer cassette 100 when in the non-blocking configuration 800.

As with examples according to FIGS. 7A and 7B, the label printer cassette 100 shown in FIGS. 8, 9A and 9B enables the label backing hub 110 to be used to roll backing 405 when the label printer cassette 100 is being used to convey label media 404 with backing 405 to be printed on, when the label printer cassette 100 is in the non-blocking configuration 800. According to examples, to roll the backing 405 onto the backing hub 110, a strip of the backing 405 from the roll 400 is typically fed back from the exit 108 back round into the cassette 100 via another opening in the cassette 100 below the exit 108, and is attached to the backing hub 110. The backing hub 110 is then rotated by a printer spindle of the printer 150 when the cassette 100 is mounted onto the printer 150, which causes winding of the backing 405 around the backing hub 110 when the media 404 is being conveyed through the cassette 100. The printer spindle of the printer 150 that rotates the backing hub 110 can for example rotate at the same time as the printer spindle of the printer 150 that rotates the hub 106 to allow media 404 to be unrolled from the roll 400.

FIG. 10 shows part of a label printer cassette 100 according to examples disclosed herein. As shown in other examples, for example as shown in FIG. 1A, the label printer cassette 100 is for providing a supply of label media 404 to a label printer 150. The label printer cassette 100 comprises: a body 102 with a cavity 104; a hub 106 situated within the cavity. The hub 106 is arranged to receive a label media roll 400 and to rotate to enable the label media roll 400 to be unrolled.

The label printer cassette 100 shown in part in FIG. 10, and in the example shown in FIG. 1 comprises a support plate 116, a side support 118 on one side of the support plate 116, a guide member 120 protruding from the plane of the support plate 116.

The label printer cassette 100 shown in part in FIG. 10 and as shown in FIG. 1A also comprises an adjustment mechanism 122 arranged to adjust the distance between the guide member 120 and the side support 118.

The support plate 116, side support 118 and guide member 120 are arranged to support and guide unrolled label media 404 from the label media roll 400 as it is conveyed from the label media roll 400 towards the exit of the cassette 100 by the label printer 150.

The arrangement of the support plate 116, side support 118, guide member 120 and the adjustment mechanism 122 enables easy placement of the label media 404 when setting up the label printer cassette 100 as the label media 404 only needs to be placed on top of the support plate 116 and between the guide number 120 and the side support 118. This is advantageous because it does not require feeding the label media 404 through any gaps between components of the label printer cassette 100, thereby making it easier to load label media 404 into the label printer cassette 100.

The adjustment mechanism 122 in combination with the guide member 120 enables easy and reliable adjustment of the position of the guide member 120 so that it can correctly align the chosen label media 404 for printing on and exit from the label printer 150. This is required for example due to using different sized labels. As the adjustment mechanism 122 and guide member 120 enable precise adjustment of the position of the guide member 120, this reduces the risk of incorrectly setting the guide number 120, or for example squeezing the label media 404 more than it should do.

According to examples, as shown in FIG. 10, the adjustment mechanism 122 comprises a gear arrangement 1120 (see FIGS. 11A-11C). In the example shown in FIG. 10, the gear arrangement is within the side support 118. In other examples, the gear arrangement 1120 is adjacent to the side support 118.

According to examples as shown in FIG. 10, the support plate 116 comprises a slot 1000. The guide member 120 is located within the slot 1000. This allows the position of the guide member 120 to be adjusted whilst protruding above the support plate 116 whilst also preventing any of the mechanisms of the adjustment mechanism 122 from coming into contact with the label media.

According to examples and as shown in FIG. 10, the support plate 1000 comprises a surface 1010 with grooves 1020. This type of surface is beneficial for use with label media 404 which has no backing and therefore has adhesive on its back surface which can come into contact with parts of the label printer cassette 100. The grooves 1020 prevent the label media 404 from sticking to the support plate 116. In other examples, for example where the label printer cassette 100 is to be used only for label media 404 with backing, the support plate 116 may instead not comprise grooves 1020.

According to examples disclosed herein, one or more other surfaces of the printer cassette 100 which label media 404 can come into contact with also comprise grooves to prevent label media 404 without backing 405 from sticking to the one or more surfaces.

According to examples and as shown in FIG. 1A and FIG. 10, the support plate 116 is inclined relative to the hub 106. This ensures that the label media 404 is guided in the right direction towards the exit 108 of the label printer cassette 100 and that also it contacts the guide member 120.

FIG. 11A-11C shows part of a label printer cassette 100 according to examples disclosed herein. In particular FIGS. 11A-11C show an example of an adjustment mechanism 122 and guide member 120. According to examples and as shown in FIGS. 11A-11C, the adjustment mechanism 112 comprises a lead-screw 1110. In this particular example, the lead screw 1110 is a spring lead-screw.

The adjustment mechanism 122 shown in FIGS. 11A-11C is arranged so that the gear arrangement 1120 is connected to the lead screw 1110. Rotational movement of a first gear of the gear arrangement 1120 in a first rotational direction 1130 translates into linear movement of the guide member in a first linear direction 1140. Rotational movement of the first gear in a second rotational direction 1150, opposite to the first rotational direction 1130, translates into linear movement of the guide member in a second linear direction 1160, opposite to the first linear direction 1140.

As shown in FIG. 11B, movement of the guide member 120 in the first linear direction 1140 increases the distance between the guide member 120 and the side support 118. As shown in FIG. 11C, movement of the guide member 120 in the second linear direction 1160 decreases the distance between the guide member 120 and the side support 118. The adjustment mechanism 122 therefore enables precise linear adjustment of the guide member 120.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

It will be appreciated that various changes and modifications can be made to the present invention without departing from the scope of the present application.

1. A label printer cassette for providing a supply of label media to a label printer comprising:
a body with a cavity;
a hub situated within the cavity, the hub being arranged to receive a label media roll and to rotate to enable the label media roll to be unrolled and conveyed towards the an exit of the cassette by the label printer;
a backing hub situated within the cavity, the backing hub arranged to receive and to roll label media backing when the label media roll has label media backing;
a moveable barrier;
wherein the label printer cassette is arranged to have a blocking configuration and a non-blocking configuration;
wherein in the blocking configuration the barrier is positioned to extend across the cavity from the backing hub towards a wall of the cavity to prevent unrolled label media from the label media roll being conveyed between the backing hub and the wall,
wherein in the blocking configuration the barrier partially surrounds the backing hub to prevent unrolled label media from touching the backing hub as it is conveyed past the backing hub;
wherein in the non-blocking configuration, the moveable barrier does not partially surround the backing hub and does not extend across the cavity from the backing hub to the wall of the cavity.

2. A label printer cassette as claimed in claim 1, wherein the printer cassette comprises a first mounting adjacent to the backing hub and a second mounting adjacent to the wall of the cavity;
wherein the moveable barrier comprises a mounting portion;
wherein each of the first mounting and the second mounting are arranged to receive the mounting portion of the moveable barrier.

3. A label printer as claimed in claim 1, wherein in the non-blocking configuration the barrier is positioned adjacent to the wall of the cavity.

4. A label printer cassette as claimed in claim 1, wherein the wall of the cavity comprises a wall mounting;
wherein the moveable barrier comprises a mounting portion;
wherein the wall mounting is arranged to receive the mounting portion of the moveable barrier.

5. A label printer cassette as claimed in claim 1, wherein a portion of the moveable barrier conforms to a portion of the backing hub when in the blocking configuration.

6. A label printer cassette as claimed in claim 1, wherein the moveable barrier is removable from the label printer cassette.

7. A label printer, and a label printer cassette as claimed in claim 1 installed into the printer, wherein the label printer cassette supplies label media to the label printer for printing labels.
